(19) United States
(12) Patent Application Publication
(10) Pub. No.: US 2022/0036877 A1
(43) Pub. Date: Feb. 3, 2022

(54) SPEECH RECOGNITION DEVICE, SPEECH RECOGNITION SYSTEM, AND SPEECH RECOGNITION METHOD

(71) Applicant: Mitsubishi Electric Corporation, Tokyo (JP)

(72) Inventors: Naoya BABA, Tokyo (JP); Yusuke KOJI, Tokyo (JP)

(73) Assignee: Mitsubishi Electric Corporation, Tokyo (JP)

(21) Appl. No.: 17/278,725

(22) PCT Filed: Oct. 15, 2018
(86) PCT No.: PCT/JP2018/038330

§ 371 Date: Mar. 23, 2021

(51) Int. Cl. G10L 15/02; G10L 15/25

(52) U.S. Cl. CPC G10L 15/02; G10L 15/25

(57) ABSTRACT

A speech signal processing unit individually separates uttered speech of a plurality of passengers each seated in one of a plurality of speech recognition target seats in a vehicle. A speech recognition unit performs speech recognition on uttered speech of each of the passengers separated by the speech signal processing unit and calculates a speech recognition score. A score-using determining unit determines a speech recognition result of which of the passengers is to be used from among speech recognition results for the passengers, using the speech recognition score of each of the passengers.

### TECHNICAL FIELD

The present invention relates to a speech recognition device, a speech recognition system, and a speech recognition method.

### BACKGROUND ART

In the related art, speech recognition devices for operating information devices in a vehicle by speech are developed. Hereinafter, a seat on which speech recognition is performed in a vehicle is referred to as a “speech recognition target seat”. Among passengers seated in speech recognition target seats, a passenger who utters speech for operation is referred to as a “speaker”. Furthermore, speech of a speaker directed to a speech recognition device is referred to as “uttered speech”.

Since various types of noise may occur in a vehicle such as conversation among passengers, noise of travelling vehicles, or guidance speech of onboard devices, there are cases where a speech recognition device erroneously recognizes uttered speech due to the noise. Therefore, a speech recognition device described in Patent Literature 1 detects speech input start time and speech input end time on the basis of sound data and determines, on the basis of image data capturing a passenger, whether a period from the speech input start time to the speech input end time is an utterance period in which the passenger is speaking. In this manner, the speech recognition device suppresses erroneous recognition of speech that the passenger has not uttered.

### CITATION LIST

### Patent Literature

Patent Literature 1: JP 2007-199552 A

### SUMMARY OF INVENTION

### Technical Problem

Here, an example is assumed in which the speech recognition device described in Patent Literature 1 is applied to a vehicle in which a plurality of passengers is onboard. In this example, in a case where another passenger moves the mouth in a manner similar to speaking such as yawning in a section in which a certain passenger is speaking, there are cases where the speech recognition device erroneously determines that the other passenger who is, for example, yawning, is speaking even though the passenger is not speaking and erroneously recognizes uttered speech of the certain passenger is as uttered speech of the other passenger. In this manner, in speech recognition devices for recognizing speech uttered by a plurality of passengers onboard a vehicle, there is a disadvantage that erroneous recognition occurs even in a case where sound data and images captured by a camera are used as in Patent Literature 1.

The present invention has been made to solve the disadvantage as the above, and an object of the invention is to suppress erroneous recognition of speech uttered by another passenger in a speech recognition device used by a plurality of passengers.

### Solution to Problem

A speech recognition device according to the present invention includes: a speech signal processing unit for individually separating uttered speech of a plurality of passengers each seated in one of a plurality of speech recognition target seats in a vehicle, a speech recognition unit for performing speech recognition on the uttered speech of each of the passengers separated by the speech signal processing unit and calculating a speech recognition score; and a score-using determining unit for determining a speech recognition result of which of the passengers is to be used from among speech recognition results for the passengers, using the speech recognition score of each of the passengers.

### Advantageous Effects of Invention

According to the present invention, it is possible to suppress erroneous recognition of speech uttered by another passenger in a speech recognition device used by a plurality of passengers.

### BRIEF DESCRIPTION OF DRAWINGS

FIG. 1 is a block diagram illustrating a configuration example of an information device including a speech recognition device according to a first embodiment.

FIG. 2A is a reference example for facilitating understanding of the speech recognition device according to the first embodiment and is a diagram illustrating an example of a situation in a vehicle.

FIG. 2B is a table illustrating a processing result by the speech recognition device of the reference example in the situation of FIG. 2A.

FIG. 3A is a diagram illustrating an example of a situation in a vehicle in the first embodiment.

FIG. 3B is a table illustrating a processing result by the speech recognition device according to the first embodiment in the situation of FIG. 3A.

FIG. 4A is a diagram illustrating an example of a situation in a vehicle in the first embodiment.

FIG. 4B is a table illustrating a processing result by the speech recognition device according to the first embodiment in the situation of FIG. 4A.

FIG. 5A is a diagram illustrating an example of a situation in a vehicle in the first embodiment.

FIG. 5B is a table illustrating a processing result by the speech recognition device according to the first embodiment in the situation of FIG. 5A.

FIG. 6 is a flowchart illustrating an example of the operation of the speech recognition device according to the first embodiment.

FIG. 7 is a block diagram illustrating a configuration example of an information device including a speech recognition device according to a second embodiment.

FIG. 8 is a table illustrating a processing result by the speech recognition device according to the second embodiment in the situation of FIG. 3A.

FIG. 9 is a table illustrating a processing result by the speech recognition device according to the second embodiment in the situation of FIG. 4A.

FIG. 10 is a table illustrating a processing result by the speech recognition device according to the second embodiment in the situation of FIG. 5A.

FIG. 11 is a flowchart illustrating an example of the operation of the speech recognition device according to the second embodiment.

FIG. 12 is a block diagram illustrating a modification of the speech recognition device according to the second embodiment.

FIG. 13 is a block diagram illustrating a configuration example of an information device including a speech recognition device according to a third embodiment.

FIG. 14 is a flowchart illustrating an example of the operation of the speech recognition device according to the third embodiment.

FIG. 15 is a table illustrating a processing result by the speech recognition device according to the third embodiment.

FIG. 16 is a block diagram illustrating a configuration example of an information device including a speech recognition device according to a fourth embodiment.

FIG. 17 is a flowchart illustrating an example of the operation of the speech recognition device according to the fourth embodiment.

FIG. 18 is a table illustrating a processing result by the speech recognition device according to the fourth embodiment.

FIG. 19A is a diagram illustrating an example of the hardware configuration of the speech recognition devices of the embodiments.

FIG. 19B is a diagram illustrating another example of the hardware configuration of the speech recognition devices of the embodiments.

### DESCRIPTION OF EMBODIMENTS

To describe the present invention further in detail, embodiments for carrying out the present invention will be described below referring to the accompanying drawings.

### First Embodiment

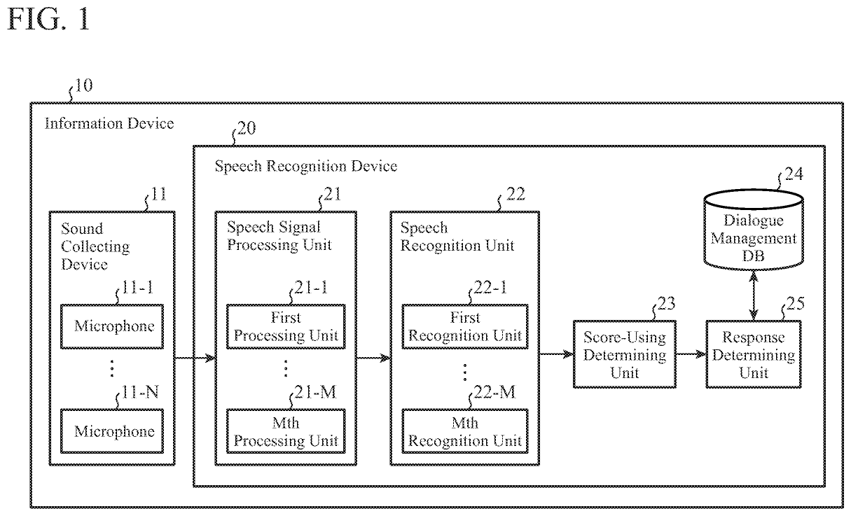

FIG. 1 is a block diagram illustrating a configuration example of an information device 10 including a speech recognition device 20 according to a first embodiment. The information device 10 is, for example, a navigation system for a vehicle or a meter display for a driver, a personal computer (PC), or a mobile information terminal such as an integrated cockpit system including a tablet PC and a smartphone. The information device 10 includes a sound collecting device 11 and a speech recognition device 20.

Note that the speech recognition device 20 that recognizes Japanese is described as an example below; however, the language that the speech recognition device 20 recognizes is not limited to Japanese.

The speech recognition device 20 includes a speech signal processing unit 21, a speech recognition unit 22, a score-using determining unit 23, a dialogue management database 24 (hereinafter referred to as the “dialogue management DB 24”), and a response determining unit 25. The speech recognition device 20 is connected with the sound collecting device 11.

The sound collecting device 11 includes N microphones 11-1 to 11-N (N is an integer greater than or equal to 2). Note that the sound collecting device 11 may be an array microphone in which omnidirectional microphones 11-1 to 11-N are arranged at constant intervals. Alternatively, directional microphones 11-1 to 11-N may be arranged in front of each speech recognition target seat of the vehicle. The sound collecting device 11 may be arranged at any position as long as speech uttered by all passengers seated in speech recognition target seats can be collected.

In the first embodiment, the speech recognition device 20 will be described on the premise that the microphones 11-1 to 11-N are included in an array microphone. The sound collecting device 11 outputs an analog signal (A1 to AN) (hereinafter referred to as “speech signal”) corresponding to speech collected by each of the microphones 11-1 to 11-N. That is, speech signals A1 to AN correspond to the microphones 11-1 to 11-N in a one-to-one basis.

The speech signal processing unit 21 first performs analog-to-digital conversion (hereinafter referred to as “AD conversion”) on the analog speech signals A1 to AN output by the sound collecting device 11 to obtain digital speech signals D1 to DN. Next, the speech signal processing unit 21 separates, from the speech signals D1 to DN, speech signals d1 to dM that contain only the uttered speech of a speaker seated in respective speech recognition target seats. Note that M is an integer less than or equal to N and corresponds to, for example, the number of speech recognition target seats. Hereinafter, the speech signal processing for separating the speech signals d1 to dM from the speech signals D1 to DN will be described in detail.

The speech signal processing unit 21 removes, out of the speech signals D1 to DN, a component that correspond to sound different from uttered speech (hereinafter, referred to as a “noise component”). Moreover, in order for the speech recognition unit 22 to be able to independently recognize the uttered speech of each of the passengers, the speech signal processing unit 21 includes M processing units of first to Mth processing units 21-1 to 21-M, and the first to Mth processing units 21-1 to 21-M output M speech signals d1 to dM obtained by the first to Mth processing units 21-1 to 21-M by extracting only the speech of a speaker seated in the respective speech recognition target seats.

A noise component includes, for example, a component corresponding to noise generated by traveling of a vehicle, a component corresponding to speech uttered by a passenger who is different from the speaker among the passengers. Various known methods such as a beam forming method, a binary masking method, or a spectral subtraction method can be used to remove noise components in the speech signal processing unit 21. Thus, detailed description of the removal of noise components in the speech signal processing unit 21 will be omitted.

Note that, in a case where the speech signal processing unit 21 uses blind source separation technology such as independent component analysis, the speech signal processing unit 21 includes one first processing unit 21-1, and the first processing unit 21-1 separates the speech signals d1 to dM from the speech signals D1 to DN. However, since a plurality of sound sources (that is, a plurality of speakers) is required in a case where the blind source separation technology is used, it is necessary to detect the number of passengers and the number of speakers by a camera 12 and an image analysis unit 26, which will be described later, and to notify the speech signal processing unit 21 of the numbers.

The speech recognition unit 22 first detects a speech section (hereinafter, referred to as an “utterance period”) corresponding to uttered speech among the speech signals d1 to dM output by the speech signal processing unit 21. Next, the speech recognition unit 22 extracts a feature amount for speech recognition from the utterance period and executes speech recognition using the feature amount. Note that the speech recognition unit 22 includes M recognition units of first to Mth recognition units 22-1 to 22-M so that speech recognition can be independently performed on uttered speech of respective passengers. The first to Mth recognition units 22-1 to 22-M output, to the score-using determining unit 23, speech recognition results of utterance periods detected from the speech signals d1 to dM, speech recognition scores indicating the reliability of the speech recognition results, and the start time and the end time of the utterance periods.

Various known methods such as the hidden Markov model (HMM) can be used for the speech recognition processing in the speech recognition unit 22. Therefore, detailed description of the speech recognition processing in the speech recognition unit 22 is omitted. The speech recognition score calculated by the speech recognition unit 22 may be a value considering both the output probability of an acoustic model and the output probability of a language model, or may be an acoustic score of only the output probability of an acoustic model.

The score-using determining unit 23 first determines whether or not there are the identical speech recognition results within a certain period of time (for example, within 1 second) among the speech recognition results output by the speech recognition unit 22. This certain period of time is a time length in which a speech recognition result of another passenger may be affected by superimposition of uttered speech of a passenger over uttered speech of the other passenger, and is given to the score-using determining unit 23 in advance. In a case where there are the identical speech recognition results within a certain period of time, the score-using determining unit 23 refers to the speech recognition score that corresponds to each of the identical speech recognition results and adopts the speech recognition result of the best score. A speech recognition result not having the best score is rejected. On the other hand, the score-using determining unit 23 adopts each of different speech recognition results in a case where there are different speech recognition results within the certain period of time.

Note that it is also conceivable that a plurality of speakers simultaneously speaks the identical content of utterance. Therefore, the score-using determining unit 23 may set a threshold value for the speech recognition score, determine that a passenger corresponding to the speech recognition result having a speech recognition score greater than or equal to the threshold value is speaking, and adopt this speech recognition result. The score-using determining unit 23 may further change the threshold value for each recognition target word. Alternatively, the score-using determining unit 23 may first perform threshold value determination of the speech recognition scores, and in a case where all the speech recognition scores of the identical speech recognition results are less than the threshold value, the score-using determining unit 23 may adopt only the speech recognition result having the best score.

In the dialogue management DB 24, the correspondence between speech recognition results and functions to be executed by the information device 10 is defined as a database. For example, a function of “decreasing the airflow volume of the air conditioner by one level” is defined for the speech recognition result of “reduce the airflow volume of the air conditioner.” In the dialogue management DB 24, information indicating whether or not a function is dependent on a speaker may be further defined.

The response determining unit 25 refers to the dialogue management DB 24 and determines a function that corresponds to the speech recognition result adopted by the score-using determining unit 23. In a case where the score-using determining unit 23 adopts a plurality of identical speech recognition results and the function is not dependent on a speaker, the response determining unit 25 determines on a speech recognition result having the best speech recognition score, that is, only a function that corresponds to the most reliable speech recognition result. The response determining unit 25 outputs the determined function to the information device 10. The information device 10 executes the function output by the response determining unit 25. The information device 10 may output response sound for notifying the passenger of execution of the function, for example, from a speaker when the function is executed.

Here, an exemplary function that is dependent on a speaker and an exemplary function that is not dependent on a speaker will be described.

For example, regarding the operation of the air conditioner, different airflow volumes and temperatures can be set for each seat, and thus it is necessary to execute a function for each speaker even when speech recognition results are the same. More specifically, let us assume that speech recognition results of uttered speech by a first passenger 1 and a second passenger 2 are “lower the temperature of the air conditioner” and that speech recognition scores of both of the speech recognition results are greater than or equal to a threshold value. In this case, the response determining unit 25 determines that the function of “decreasing the airflow volume of the air conditioner by one level” that corresponds to the speech recognition result of “lower the temperature of the air conditioner” is dependent on a speaker and executes a function of lowering the temperature of the air conditioner for the first passenger 1 and the second passenger 2.

Meanwhile, as for functions such as destination search and reproducing music that are not dependent on a speaker but are shared by all passengers, it is not necessary to execute such function for each speaker when speech recognition results are identical. Therefore, in a case where there are a plurality of identical speech recognition results and a function that corresponds to the speech recognition results is not dependent on a speaker, the response determining unit 25 determines a function that corresponds to only the speech recognition result of the best score. More specifically, let us assume that speech recognition results of uttered speech by the first passenger 1 and the second passenger 2 are “play music” and that speech recognition scores of both of the speech recognition results are greater than or equal to a threshold value. In this case, the response determining unit 25 determines that the function of “reproducing music” that corresponds to the speech recognition result of “play music” is not dependent on a speaker and executes a function that corresponds to the one with a higher speech recognition score out of the speech recognition result of the first passenger 1 and the speech recognition result of the second passenger 2.

Next, a specific example of the operation of the speech recognition device 20 will be described.

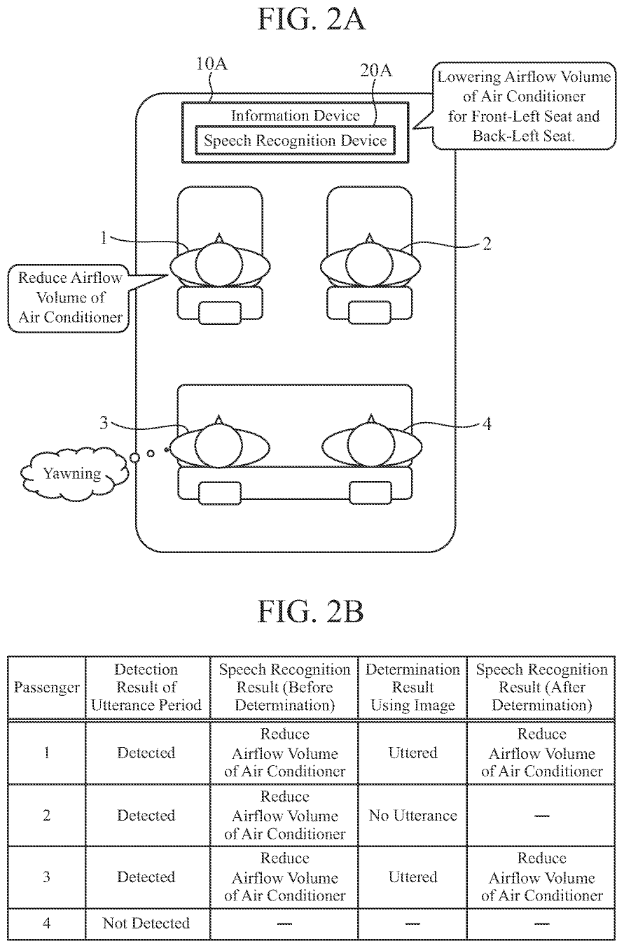

First, a reference example for facilitating understanding of the speech recognition device 20 according to the first embodiment will be described with reference to FIGS. 2A and 2B. In FIG. 2A, an information device 10A and a speech recognition device 20A of a reference example are installed in a vehicle. The speech recognition device 20A of the reference example corresponds to the speech recognition device described in Patent Literature 1 described earlier. FIG. 2B is a table illustrating a processing result by the speech recognition device 20 of the reference example in the situation of FIG. 2A.

In FIG. 2A, four passengers of first to fourth passengers 1 to 4 are seated in speech recognition target seats of the speech recognition device 20A. The first passenger 1 is speaking “reduce the airflow volume of the air conditioner”. The second passenger 2 and the fourth passenger 4 are not speaking. The third passenger 3 happens to be yawning while the first passenger 1 is speaking. The speech recognition device 20A detects an utterance period using a speech signal and determines whether the utterance period is an appropriate utterance period by using an image captured by a camera (that is, whether there is utterance or not). In this situation, the speech recognition device 20A should output only the speech recognition result of “reduce the airflow volume of the air conditioner” of the first passenger 1. However, since the speech recognition device 20A performs speech recognition not only for the first passenger 1 but also for the second passenger 2, the third passenger 3, and the fourth passenger 4, there are cases where speech is erroneously detected also for the second passenger 2 and the third passenger 3 as illustrated in FIG. 2B. As for the second passenger 2, the speech recognition device 20A can determine that the second passenger 2 is not speaking by determining whether or not the second passenger 2 is speaking using the image captured by the camera and can reject the speech recognition result of “reduce the airflow volume of the air conditioner”. Meanwhile, in a case where the third passenger 3 happens to be yawning and the mouth is moving in a similar manner to speaking, the speech recognition device 20A erroneously determines that the third passenger 3 is speaking even though the determination whether the third passenger 3 is speaking is made using the image captured by the camera. Then, the erroneous recognition that the third passenger 3 is speaking “reduce the airflow volume of the air conditioner” occurs. In this case, the information device 10A erroneously responds “lowering the airflow volume of the air conditioner for the front-left seat and the back-left seat” in accordance with the speech recognition result of the speech recognition device 20A.

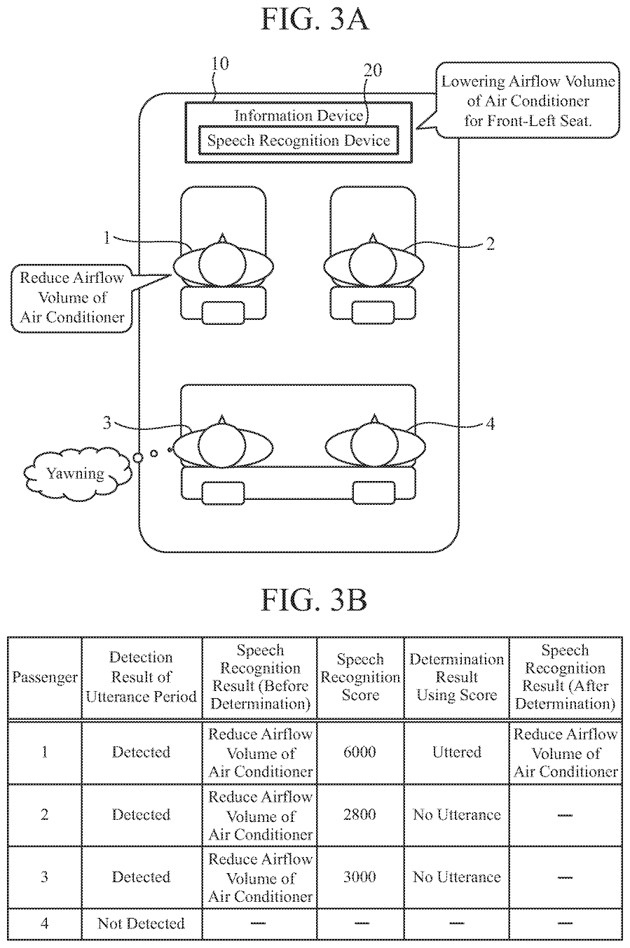

FIG. 3A is a diagram illustrating an example of a situation in the vehicle in the first embodiment. FIG. 3B is a table illustrating a processing result by the speech recognition device 20 according to the first embodiment in the situation of FIG. 3A. In FIG. 3A, the first passenger 1 is speaking “reduce the airflow volume of the air conditioner” as in FIG. 2A. The second passenger 2 and the fourth passenger 4 are not speaking. The third passenger 3 happens to be yawning while the first passenger 1 is speaking. In a case where the speech signal processing unit 21 has not been able to completely separate the uttered speech of the first passenger 1 from speech signals d2 and d3, the uttered speech of the first passenger 1 remains in the speech signal d2 of the second passenger 2 and the speech signal d3 of the third passenger 3. In this case, the speech recognition unit 22 detects utterance periods from the speech signals d1 to d3 of the first to third passengers 1 to 3 and recognizes the speech of “reduce the airflow volume of the air conditioner”. However, since the speech signal processing unit 21 has attenuated the uttered speech component of the first passenger 1 from the speech signal d2 of the second passenger 2 and the speech signal d3 of the third passenger 3, speech recognition scores that correspond to the speech signals d2 and d3 are lower than the speech recognition score of the speech signal d1 in which the uttered speech is emphasized. The score-using determining unit 23 compares speech recognition scores that correspond to the identical speech recognition results for the first to third passengers 1 to 3 and adopts only the speech recognition result of the first passenger 1 that corresponds to the best speech recognition score. The score-using determining unit 23 further determines the speech recognition results of the second passenger 2 and the third passenger 3 as not speaking since they do not have the best speech recognition score and rejects the speech recognition results. As a result, the speech recognition device 20 can reject unnecessary speech recognition result that corresponds to the third passenger 3 and can appropriately adopt the speech recognition result of only the first passenger 1. In this case, the information device 10 can return a correct response of “lowering the airflow volume of the air conditioner for the front-left seat” in accordance with the speech recognition result of the speech recognition device 20.

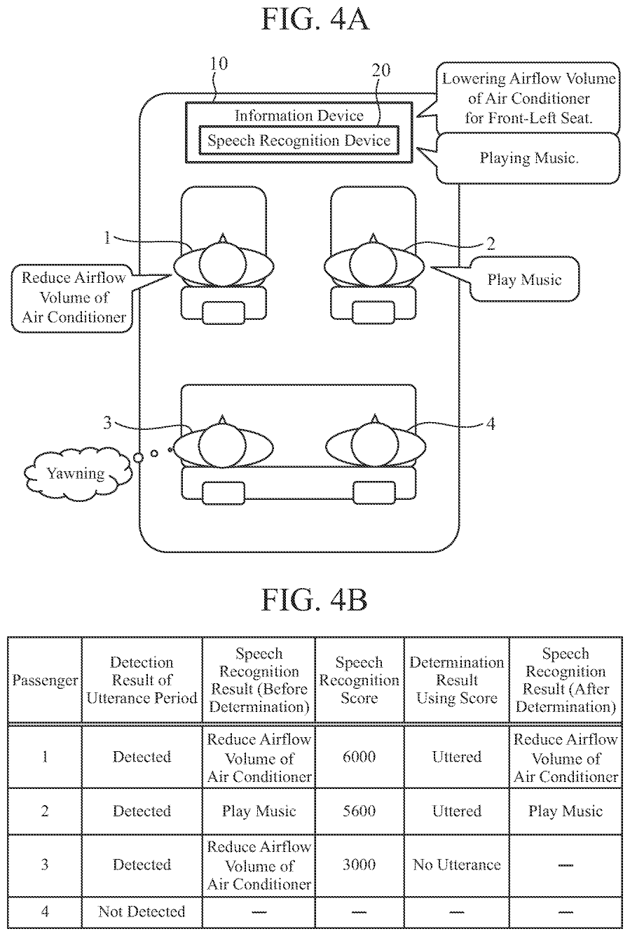

FIG. 4A is a diagram illustrating an example of a situation in the vehicle in the first embodiment. FIG. 4B is a table illustrating a processing result by the speech recognition device 20 according to the first embodiment in the situation of FIG. 4A. In the example of FIG. 4A, the first passenger 1 is speaking “reduce the airflow volume of the air conditioner” while the second passenger 2 is speaking “play music”. The third passenger 3 is yawning while the first passenger 1 and the second passenger 2 are speaking. The fourth passenger 4 is not speaking. Despite the state in which the third passenger 3 is not speaking, the speech recognition unit 22 recognizes the speech of “reduce the airflow volume of the air conditioner” for the first passenger 1 and the third passenger 3. However, the score-using determining unit 23 adopts the speech recognition result of the first passenger 1 having the best speech recognition score and rejects the speech recognition result of the third passenger 3. Meanwhile, the speech recognition result of “play music” of the second passenger 2 is different from the speech recognition results of the first passenger 1 and the third passenger 3, and thus the score-using determining unit 23 adopts the speech recognition result of the second passenger 2 without making comparison among the speech recognition scores. In this case, the information device 10 can return the correct responses of “lowering the airflow volume of the air conditioner for the front-left seat” and “playing music” in accordance with the speech recognition results of the speech recognition device 20.

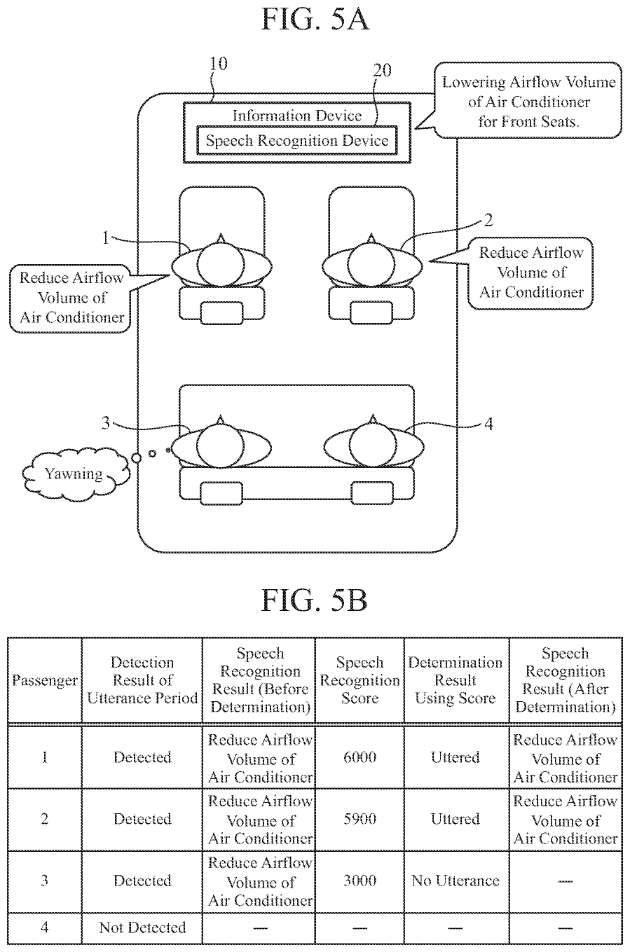

FIG. 5A is a diagram illustrating an example of a situation in the vehicle in the first embodiment. FIG. 5B is a table illustrating a processing result by the speech recognition device 20 according to the first embodiment in the situation of FIG. 5A. In FIG. 5A, the first passenger 1 and the second passenger 2 are speaking “reduce the airflow volume of the air conditioner” substantially at the same time, and the third passenger 3 is yawning while they are speaking. The fourth passenger 4 is not speaking. The third passenger 3 is yawning while the first passenger 1 and the second passenger 2 are speaking. The fourth passenger 4 is not speaking. Despite the state in which the third passenger 3 is not speaking, the speech recognition unit 22 recognizes the speech of “reduce the airflow volume of the air conditioner” for the first passenger 1, the second passenger 2, and the third passenger 3. In this example, the score-using determining unit 23 compares a threshold value of “5000” for speech recognition scores with the speech recognition scores that correspond to the identical speech recognition results of the first to third passengers 1 to 3. Then, the score-using determining unit 23 adopts the speech recognition results of the first passenger 1 and the second passenger 2 having a speech recognition score greater than or equal to the threshold value “5000”. Meanwhile, the score-using determining unit 23 rejects the speech recognition result of the third passenger 3 having a speech recognition score less than the threshold value “5000”. In this case, the information device 10 can return a correct response of “lowering the airflow volume of the air conditioner for the front seats” in accordance with the speech recognition results of the speech recognition device 20.

Next, an example of the operation of the speech recognition device 20 will be described.

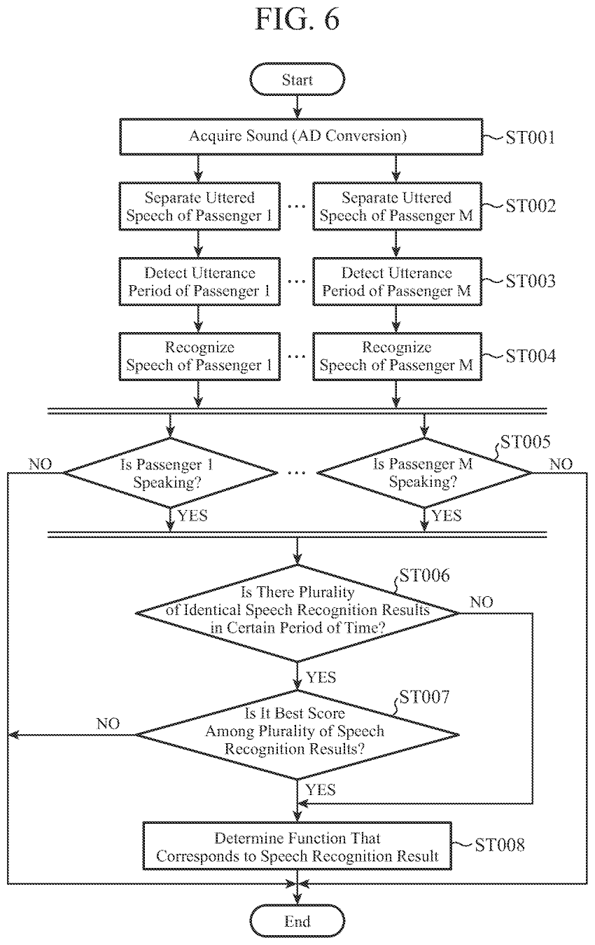

FIG. 6 is a flowchart illustrating an example of the operation of the speech recognition device 20 according to the first embodiment. The speech recognition device 20 repeats the operation illustrated in the flowchart of FIG. 6, for example, while the information device 10 is operating.

In step ST001, the speech signal processing unit 21 AD-converts speech signals A1 to AN output by the sound collecting device 11 into speech signals D1 to DN.

In step ST002, the speech signal processing unit 21 executes speech signal processing for removing noise components on the speech signals D1 to DN to obtain speech signals d1 to dM, in which the content of utterance is separated for each of passengers seated in speech recognition target seats. For example in a case where the first to fourth passengers 1 to 4 are seated in the vehicle as illustrated in FIG. 3A, the speech signal processing unit 21 outputs the speech signal d1 emphasizing the direction of the first passenger 1, the speech signal d2 emphasizing the direction of the second passenger 2, the speech signal d3 emphasizing the direction of the third passenger 3, and the speech signal d4 emphasizing the direction of the fourth passenger 4.

In step ST003, the speech recognition unit 22 detects utterance periods for the respective passengers using the speech signals d1 to dM. In step ST004, the speech recognition unit 22 extracts feature amounts of speech that corresponds to the detected utterance periods by using the speech signals d1 to dM, executes speech recognition, and calculates speech recognition scores.

Note that, in the example of FIG. 6, the speech recognition unit 22 and the score-using determining unit 23 do not execute processes after step ST004 on a passenger for whom no utterance period has been detected in step ST003.

In step ST005, the score-using determining unit 23 compares the speech recognition scores of speech recognition results output by the speech recognition unit 22 with a threshold value, determines a passenger who corresponds to a speech recognition result having a speech recognition score greater than or equal to the threshold value as being speaking, and outputs the speech recognition result to the score-using determining unit 23 (“YES” in step ST005). On the other hand, the score-using determining unit 23 determines a passenger who corresponds to a speech recognition result having a speech recognition score less than the threshold value as not being speaking (“NO” in step ST005).

In step ST006, the score-using determining unit 23 determines whether or not there is a plurality of identical speech recognition results within a certain period of time among speech recognition results that correspond to passengers who are determined to be speaking. If the score-using determining unit 23 determines that there is a plurality of identical speech recognition results within a certain period of time (“YES” in step ST006), the score-using determining unit 23 adopts a speech recognition result having the best score among the plurality of identical speech recognition results in step ST007 (“YES” in step ST007). In step ST008, the response determining unit 25 refers to the dialogue management DB 24 and determines the function that corresponds to the speech recognition result adopted by the score-using determining unit 23. On the other hand, the score-using determining unit 23 rejects speech recognition results other than the speech recognition result having the best score among the plurality of identical speech recognition results (“NO” in step ST007).

If there is one speech recognition result that corresponds to a passenger who is determined to be speaking within a certain period of time, or if there is a plurality of speech recognition results within a certain period of time but the speech recognition results are not identical (“NO” in step ST006), the process proceeds to step ST008. In step ST008, the response determining unit 25 refers to the dialogue management DB 24 and determines the function that corresponds to the speech recognition result adopted by the score-using determining unit 23.

Note that although the score-using determining unit 23 executes the threshold value determination in step ST005 in FIG. 6, the threshold value determination may not be performed. Incidentally, although the score-using determining unit 23 adopts a speech recognition result having the best score in step ST007, a speech recognition result having a speech recognition score greater than or equal to the threshold value may be adopted. The response determining unit 25 may further consider whether or not the function is dependent on a speaker when determining a function that corresponds to the speech recognition result in step ST008.

As described above, the speech recognition device 20 according to the first embodiment includes the speech signal processing unit 21, the speech recognition unit 22, and the score-using determining unit 23. The speech signal processing unit 21 separates uttered speech of a plurality of passengers seated in a plurality of speech recognition target seats in a vehicle into uttered speech of each of the passengers. The speech recognition unit 22 performs speech recognition on uttered speech of each of the passengers separated by the speech signal processing unit 21 and calculates a speech recognition score. The score-using determining unit 23 determines to which passenger, a speech recognition result corresponds, to adopt from among speech recognition results for the respective passengers using a speech recognition score of each of the passengers. With this configuration, it is possible to suppress erroneous recognition of speech uttered by another passenger in the speech recognition device 20 used by a plurality of passengers.

Moreover, the speech recognition device 20 according to the first embodiment includes the dialogue management DB 24 and the response determining unit 25. The dialogue management DB 24 defines the correspondence between speech recognition results and functions to be executed. The response determining unit 25 refers to the dialogue management DB 24 and determines a function that corresponds to the speech recognition result adopted by the score-using determining unit 23. With this configuration, in the information device 10 operated by a plurality of passengers by speech, it is possible to suppress erroneous execution of a function for speech uttered by another passenger.

Note that, although the example has been described in the first embodiment in which the speech recognition device 20 includes the dialogue management DB 24 and the response determining unit 25, the information device 10 may include the dialogue management DB 24 and the response determining unit 25. In this case, the score-using determining unit 23 outputs the adopted speech recognition result to the response determining unit 25 of the information device 10.

### Second Embodiment

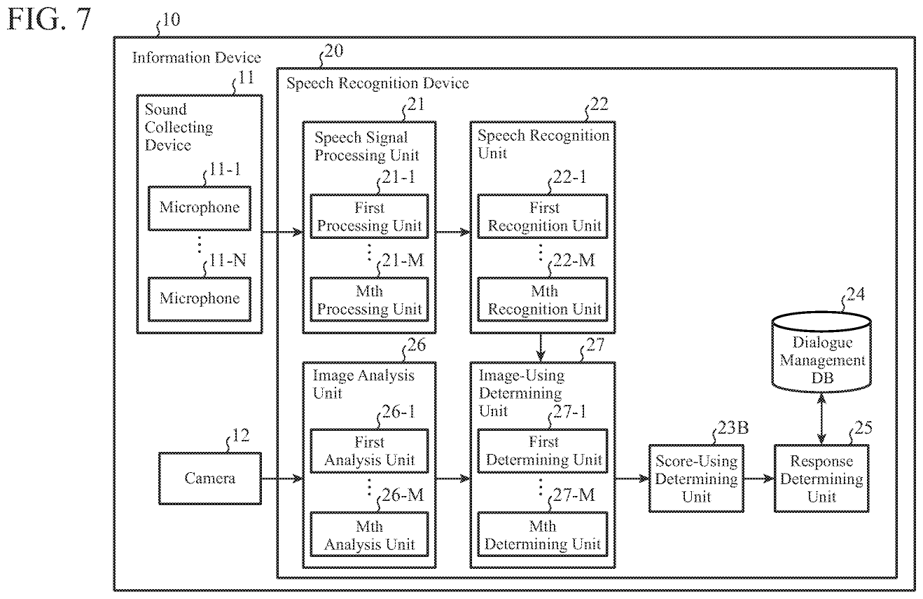

FIG. 7 is a block diagram illustrating a configuration example of an information device 10 including a speech recognition device 20 according to a second embodiment. The information device 10 according to the second embodiment has a configuration in which a camera 12 is added to the information device 10 according to the first embodiment illustrated in FIG. 1. The speech recognition device 20 according to the second embodiment has a configuration in which an image analysis unit 26 and an image-using determining unit 27 are further added to the speech recognition device 20 of the first embodiment illustrated in FIG. 1. In FIG. 7, the same or a corresponding part as that in FIG. 1 is denoted by the same symbol, and description thereof is omitted.

The camera 12 images the inside of a vehicle. The camera 12 includes, for example, an infrared camera or a visible light camera and has an angle of view that allows at least a range including the faces of passengers seated in speech recognition target seats to be captured. Note that the camera 12 may include a plurality of cameras in order to capture images of the faces of all passengers seated in the respective speech recognition target seats.

The image analysis unit 26 acquires image data captured by the camera 12 at constant cycles such as 30 frames per second (fps) and extracts a face feature amount that is a face-related feature amount from the image data. A face feature amount includes coordinate values of the upper lip and the lower lip and the opening degree of the mouth, for example. Note that the image analysis unit 26 has M analysis units of first to Mth analysis units 26-1 to 26-M so that face feature amounts of the respective passengers can be extracted independently. The first to Mth analysis units 26-1 to 26-M output the face feature amounts of the respective passengers and time when the face feature amounts have been extracted (hereinafter referred to as “face feature amount extracted time”) to the image-using determining unit 27.

The image-using determining unit 27 extracts a face feature amount that corresponds to an utterance period using the start time and the end time of the utterance period output by the speech recognition unit 22 and a face feature amount and face feature amount extracted time output by the image analysis unit 26. Then, the image-using determining unit 27 determines whether or not the passenger is speaking from the face feature amount that corresponds to the utterance period. Note that the image-using determining unit 27 has M determining units of first to Mth determining units 27-1 to 27-M so that whether or not there is utterance can be independently determined for each of the passengers. For example, the first determining unit 27-1 determine whether or not the first passenger 1 is speaking by extracting a face feature amount that corresponds to an utterance period of the first passenger 1 using the start time and the end time of the utterance period of the first passenger 1 output by a first recognition unit 22-1 and a face feature amount and face feature amount extracted time of the first passenger 1 output by the first analysis unit 26-1. The first to Mth determining units 27-1 to 27-M outputs the utterance determination results of the respective passengers using images, speech recognition results, and speech recognition scores of the speech recognition results to a score-using determining unit 23B.

Note that the image-using determining unit 27 may determine whether or not there is utterance by quantifying, for example, the opening degree of the mouth included in a face feature amount and comparing the quantized opening degree of the mouth with a predetermined threshold value. Alternatively, an utterance model and a non-utterance model may be created in advance for example by machine learning using training images, and the image-using determining unit 27 may determine whether or not there is utterance using these models. The image-using determining unit 27 may further calculate a determination score indicating the reliability of determination when the determination is made using the models.

Here, the image-using determining unit 27 determines whether or not there is utterance only for a passenger for whom the speech recognition unit 22 has detected an utterance period. For example in the situation illustrated in FIG. 3A, the first to third recognition units 22-1 to 22-3 have detected utterance periods for the first to third passengers 1 to 3, and thus the first to third determining units 27-1 to 27-3 determine whether the first to third passengers 1 to 3 are speaking. Meanwhile, the fourth determining unit 27-4 does not determine whether or not the fourth passenger 4 is speaking since the fourth recognition unit 22-4 has detected no utterance period for the fourth passenger 4.

The score-using determining unit 23B operates similarly to the score-using determining unit 23 of the first embodiment. However, the score-using determining unit 23B determines which speech recognition result is to be adopted using a speech recognition result of a passenger determined by the image-using determining unit 27 to be speaking and a speech recognition score of the speech recognition result.

Next, a specific example of the operation of the speech recognition device 20 will be described.

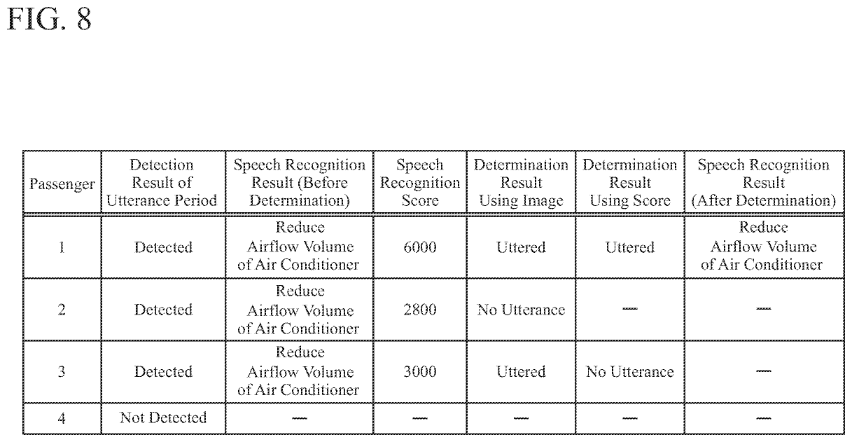

FIG. 8 is a table illustrating a processing result by the speech recognition device 20 according to the second embodiment in the situation of FIG. 3A. The image-using determining unit 27 determines whether or not the first to third passengers 1 to 3 are speaking for whom an utterance period has been detected by the speech recognition unit 22. Since the first passenger 1 is speaking “reduce the airflow volume of the air conditioner”, the image-using determining unit 27 determines that there is utterance. Since the second passenger 2 closes the mouth, the image-using determining unit 27 determines there is no utterance. Since the third passenger 3 has been yawning and has moved the mouth in a similar manner to speaking, the image-using determining unit 27 erroneously determines that there is utterance. The score-using determining unit 23B compares speech recognition scores that correspond to the identical speech recognition results for the first passenger 1 and the third passenger 3 determined to be speaking by the image-using determining unit 27 and adopts only the speech recognition result of the first passenger 1 that corresponds to the best speech recognition score.

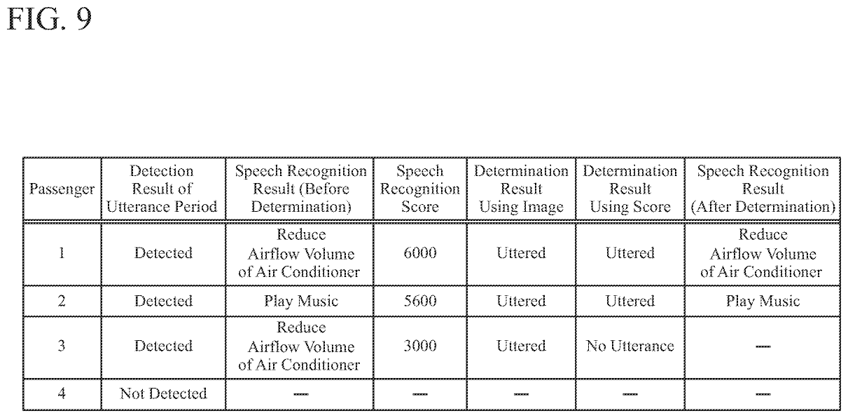

FIG. 9 is a table illustrating a processing result by the speech recognition device 20 according to the second embodiment in the situation of FIG. 4A. The image-using determining unit 27 determines whether or not the first to third passengers 1 to 3 are speaking for whom an utterance period has been detected by the speech recognition unit 22. Since the first passenger 1 is speaking “reduce the airflow volume of the air conditioner”, the image-using determining unit 27 determines that there is utterance. Since the second passenger 2 is speaking “play music”, the image-using determining unit 27 determines that there is utterance. Since the third passenger 3 has been yawning and has moved the mouth in a similar manner to speaking, the image-using determining unit 27 erroneously determines that there is utterance. The score-using determining unit 23B compares speech recognition scores that correspond to the identical speech recognition results for the first passenger 1 and the third passenger 3 determined to be speaking by the image-using determining unit 27 and adopts only the speech recognition result of the first passenger 1 that corresponds to the best speech recognition score. Meanwhile, the speech recognition result of “play music” of the second passenger 2 is different from the speech recognition results of the first passenger 1 and the third passenger 3, and thus the score-using determining unit 23B adopts the speech recognition result of the second passenger 2 without making comparison among the speech recognition scores.

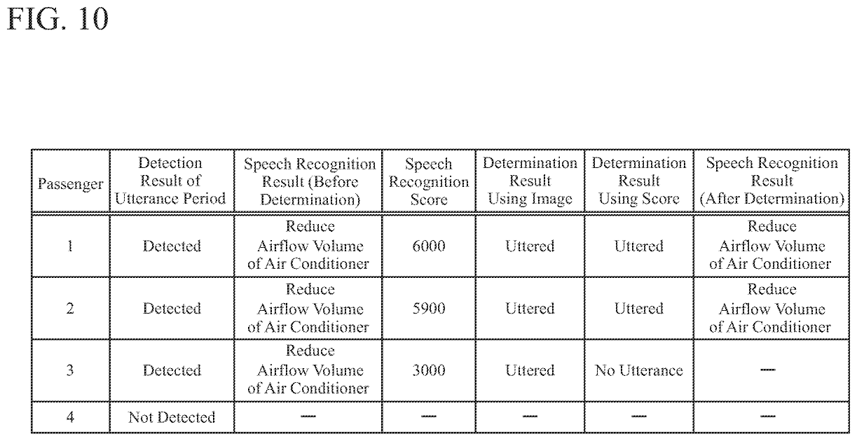

FIG. 10 is a table illustrating a processing result by the speech recognition device 20 according to the second embodiment in the situation of FIG. 5A. The image-using determining unit 27 determines whether or not the first to third passengers 1 to 3 are speaking for whom an utterance period has been detected by the speech recognition unit 22. Since the first passenger 1 and the second passenger 2 are speaking “reduce the airflow volume of the air conditioner”, the image-using determining unit 27 determines that there is utterance. Since the third passenger 3 has been yawning and has moved the mouth in a similar manner to speaking, the image-using determining unit 27 erroneously determines that there is utterance. In this example, the score-using determining unit 23B compares a threshold value of “5000” for speech recognition scores with the speech recognition scores that correspond to the identical speech recognition results of the first to third passengers 1 to 3. Then, the score-using determining unit 23B adopts the speech recognition results of the first passenger 1 and the second passenger 2 having a speech recognition score greater than or equal to the threshold value “5000”.

Next, an example of the operation of the speech recognition device 20 will be described.

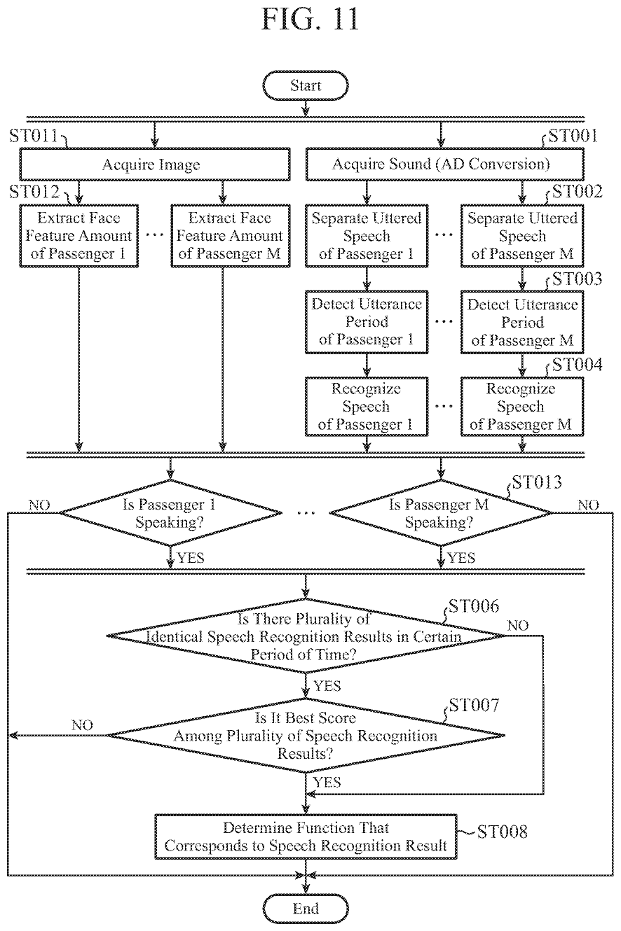

FIG. 11 is a flowchart illustrating an example of the operation of the speech recognition device 20 according to the second embodiment. The speech recognition device 20 repeats the operation illustrated in the flowchart of FIG. 11, for example, while the information device 10 is operating. Since steps ST001 to ST004 in FIG. 11 are the same operation as steps ST001 to ST004 in FIG. 6 in the first embodiment, description thereof will be omitted.

In step ST011, the image analysis unit 26 acquires image data from the camera 12 at constant cycles. In step ST012, the image analysis unit 26 extracts a face feature amount for each of the passengers seated in the speech recognition target seats from the acquired image data and outputs the face feature amount and the face feature amount extracted time to the image-using determining unit 27.

In step ST013, the image-using determining unit 27 extracts a face feature amount that corresponds to an utterance period using the start time and the end time of the utterance period output by the speech recognition unit 22 and a face feature amount and face feature amount extracted time output by the image analysis unit 26. Then, the image-using determining unit 27 determines that a passenger, whose utterance period has been detected and whose mouth moves in a similar manner to speaking in the utterance period (“YES” in step ST013). Meanwhile, the image-using determining unit 27 determines that a passenger, whose utterance period has not been detected, or a passenger, whose utterance period has been detected but whose mouth does not move in a similar manner to speaking in the utterance period, as not being speaking (“NO” in step ST013).

In steps ST006 to ST008, the score-using determining unit 23B determines whether or not there is a plurality of identical speech recognition results within a certain period of time among speech recognition results that correspond to passengers determined to be speaking by the image-using determining unit 27. Note that the operation of steps ST006 to ST008 by the score-using determining unit 23B is the same as the operation of steps ST006 to ST008 of FIG. 6 in the first embodiment, description thereof will be omitted.

As described above, the speech recognition device 20 according to the second embodiment includes the image analysis unit 26 and the image-using determining unit 27. The image analysis unit 26 calculates the face feature amount for each passenger using an image capturing a plurality of passengers. The image-using determining unit 27 determines whether or not each of the passengers is speaking by using the face feature amount from the start time to the end time of uttered speech of each of the passengers. In a case where there are identical speech recognition results that correspond to two or more passengers determined to be speaking by the image-using determining unit 27, the score-using determining unit 23B determines whether or not to adopt the speech recognition results using speech recognition scores of the respective two or more passengers. With this configuration, in the speech recognition device 20 used by a plurality of passengers, it is possible to further suppress erroneous recognition of speech uttered by another passenger.

Note that although the score-using determining unit 23B of the second embodiment determines whether or not to adopt a speech recognition result using a speech recognition score, the score-using determining unit 23B may determine whether or not to adopt a speech recognition result by also considering a determination score calculated by the image-using determining unit 27. In this case, the score-using determining unit 23B uses, for example, a value obtained by adding or averaging the speech recognition score and the determination score calculated by the image-using determining unit 27 instead of the speech recognition score. With this configuration, the speech recognition device 20 can further suppress erroneous recognition of speech uttered by another passenger.

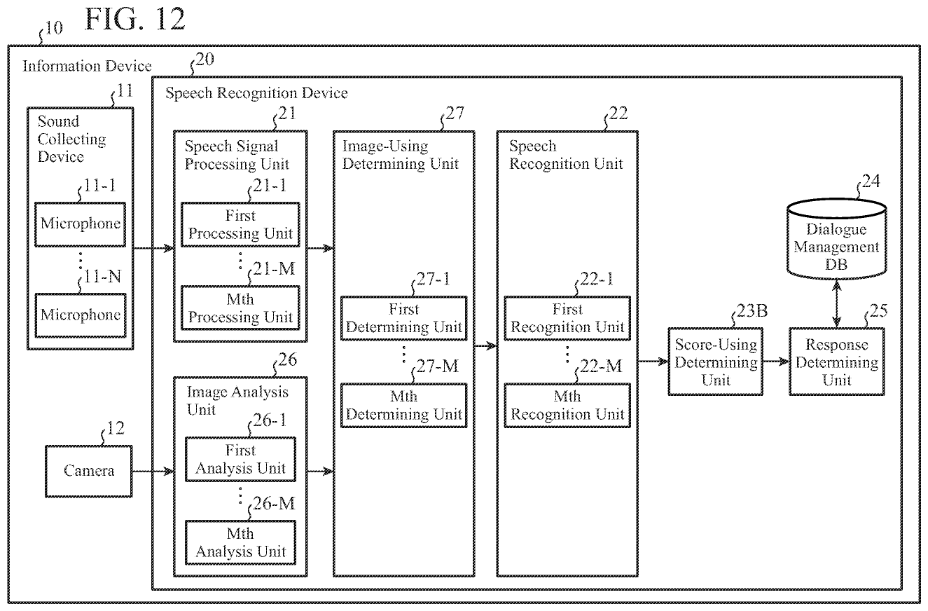

FIG. 12 is a block diagram illustrating a modification of the speech recognition device 20 according to the second embodiment. As illustrated in FIG. 12, an image-using determining unit 27 determines the start time and the end time of an utterance period in which a passenger is speaking using a face feature amount output by an image analysis unit 26 and outputs the presence or absence of the utterance period and the determined utterance period to a speech recognition unit 22. The speech recognition unit 22 performs speech recognition on the utterance period determined by the image-using determining unit 27 out of speech signals d1 to dM acquired from a speech signal processing unit 21 via the image-using determining unit 27. That is, the speech recognition unit 22 performs speech recognition on uttered speech in the utterance period of a passenger determined to have the utterance period by the image-using determining unit 27 and does not perform speech recognition on uttered speech of a passenger determined to have no utterance period. With this configuration, the processing load of the speech recognition device 20 can be reduced. Furthermore, although there is a possibility that an utterance period cannot be detected due to a reason such as the uttered speech is small in a case where the speech recognition unit 22 detects an utterance period using speech signals d1 to dM (for example the first embodiment), the performance of determining utterance periods is improved by determining an utterance period using a face feature amount by the image-using determining unit 27. Note that the speech recognition unit 22 may acquire the speech signals d1 to dM from the speech signal processing unit 21 without passing through the image-using determining unit 27.

### Third Embodiment

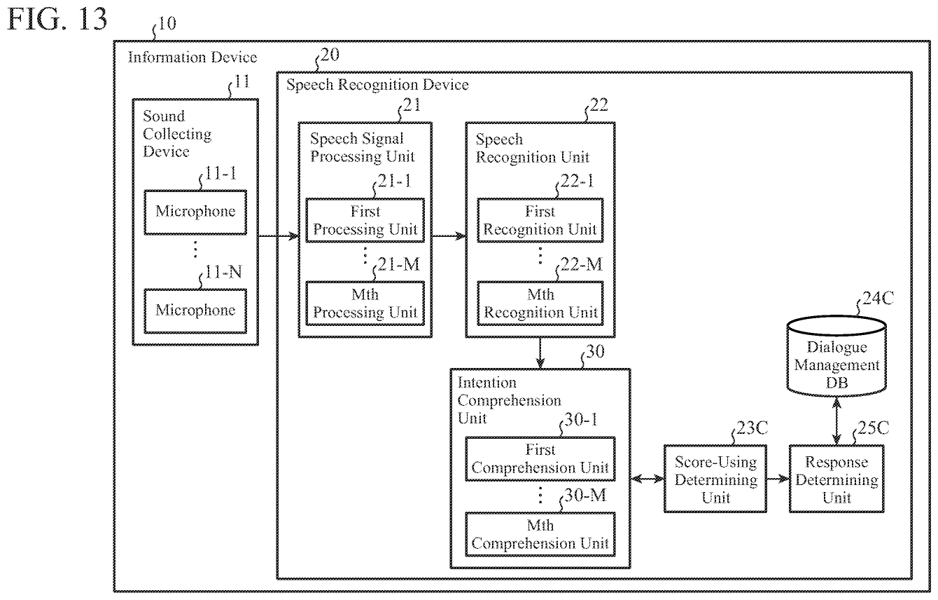

FIG. 13 is a block diagram illustrating a configuration example of an information device 10 including a speech recognition device 20 according to a third embodiment. The speech recognition device 20 according to the third embodiment has a configuration in which an intention comprehension unit 30 is added to the speech recognition device 20 of the first embodiment illustrated in FIG. 1. In FIG. 13, the same or a corresponding part as that in FIG. 1 is denoted by the same symbol, and description thereof is omitted.

The intention comprehension unit 30 performs an intention comprehension process on speech recognition results of respective passengers output by a speech recognition unit 22. The intention comprehension unit 30 outputs intention comprehension results of the respective passengers and intention comprehension scores indicating the reliability of the intention comprehension results to a score-using determining unit 23C. Note that, similarly to the speech recognition unit 22, the intention comprehension unit 30 includes M comprehension units of first to Mth comprehension units 30-1 to 30-M that correspond to respective speech recognition target seats so that the intention comprehension process can be independently performed on the content of utterance of the respective passengers.

In order for the intention comprehension unit 30 to execute the intention comprehension process, for example, assumed content of utterance is written into a text, and a model such as a vector space model in which the text is classified for each intention is prepared. The intention comprehension unit 30 calculates the similarity, such as cosine similarity, among word vector of a speech recognition result and word vector of a group of texts classified in advance for each intention using a prepared vector space model when executing the intention comprehension process. Then, the intention comprehension unit 30 sets intention having the highest similarity as the intention comprehension result. In this example, an intention comprehension score corresponds to the degree of similarity.

The score-using determining unit 23C first determines whether or not there are identical intention comprehension results within a certain period of time among the intention comprehension results output by the intention comprehension unit 30. In a case where there are the identical intention comprehension results within a certain period of time, the score-using determining unit 23C refers to the intention comprehension scores that correspond to the respective identical intention comprehension results and adopts the intention comprehension result of the best score. An intention comprehension result not having the best score is rejected. Alternatively, similarly to the first and second embodiments, the score-using determining unit 23C may set a threshold value for intention comprehension scores, determine that a passenger who corresponds to an intention comprehension result having an intention comprehension score greater than or equal to the threshold value is speaking, and adopt this intention comprehension result. In a case where the score-using determining unit 23C first performs threshold value determination of intention comprehension scores, and all the intention comprehension scores of the identical intention comprehension results are less than the threshold value, the score-using determining unit 23C may adopt only the intention comprehension result of the best score.

Note that although the score-using determining unit 23C determines whether or not to adopt an intention comprehension result using an intention comprehension score as described above, the score-using determining unit 23C may determine whether or not to adopt an intention comprehension result using a speech recognition score calculated by the speech recognition unit 22. In this case, the score-using determining unit 23C may acquire the speech recognition scores calculated by the speech recognition unit 22 from the speech recognition unit 22 or via the intention comprehension unit 30. Then, the score-using determining unit 23C determines that, for example, a passenger, who corresponds to an intention comprehension result that corresponds to a speech recognition result having a speech recognition score greater than or equal to the threshold value, is speaking and adopts this intention comprehension result.

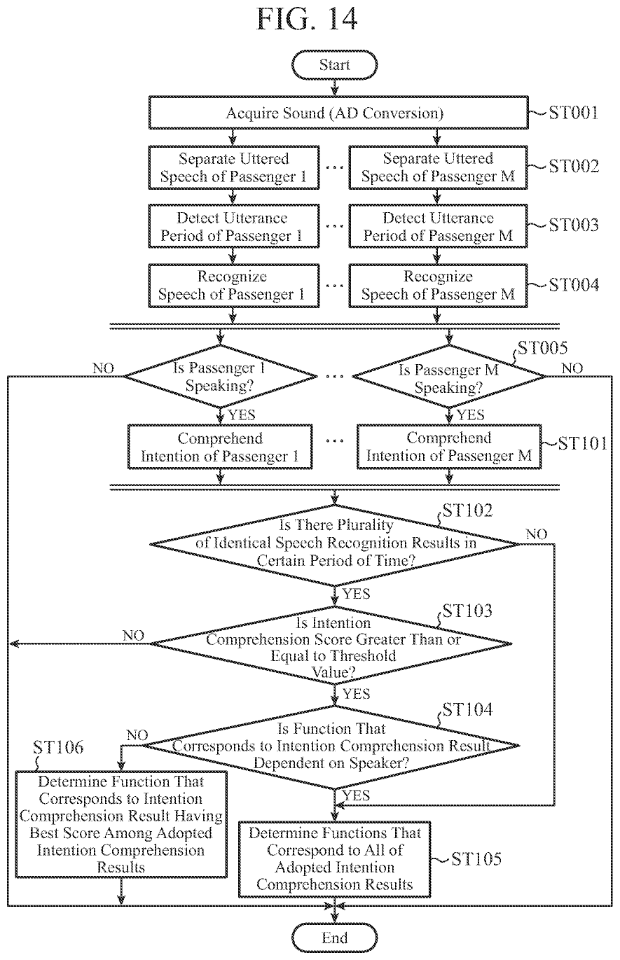

In this case, the score-using determining unit 23C may first determine whether or not the passenger is speaking using the speech recognition score, and then the intention comprehension unit 30 may execute the intention comprehension process only on the speech recognition result of the passenger determined to be speaking by the score-using determining unit 23C. This example will be described in detail in FIG. 14.

Further alternatively, the score-using determining unit 23C may determine whether or not to adopt an intention comprehension result in consideration of not only the intention comprehension score but also the speech recognition score. In this case, the score-using determining unit 23C uses, for example, a value obtained by adding or averaging the intention comprehension score and the speech recognition score instead of the intention comprehension score.

In a dialogue management DB 24C, the correspondence between intention comprehension results and functions to be executed by the information device 10 is defined as a database. For example, assuming that intention that corresponds to the utterance of “reduce the airflow volume of the air conditioner” is “ControlAirConditioner (volume=down)”, the function of “decreasing the airflow volume of the air conditioner by one level” is defined for this intention. Similarly to the first and second embodiments, information indicating whether or not a function is dependent on a speaker may be further defined in the dialogue management DB 24C.

A response determining unit 25C refers to the dialogue management DB 24C and determines a function that corresponds to the intention comprehension result adopted by the score-using determining unit 23C. Moreover, in a case where the score-using determining unit 23C adopts a plurality of identical intention comprehension results, the response determining unit 25C determines only a function that corresponds to an intention comprehension result having the best intention comprehension score if the function is not dependent on a speaker. The response determining unit 25C outputs the determined function to the information device 10. The information device 10 executes the function output by the response determining unit 25C. The information device 10 may output response sound for notifying the passenger of execution of the function, for example, from a speaker when the function is executed.

Here, an exemplary function that is dependent on a speaker and an exemplary function that is not dependent on a speaker will be described.

Similarly to the first and second embodiments, regarding the operation of the air conditioner, different airflow volumes and temperatures can be set for each seat, and thus it is necessary to execute a function for each speaker even when intention comprehension results are the same. More specifically, let us assume that the speech recognition result of the first passenger 1 is “lower the temperature of the air conditioner”, that the speech recognition result of the second passenger 2 is “ifs hot”, that the intention comprehension results of the first passenger 1 and the second passenger 2 are “ControlAirConditioner (tempereature=down)”, and that the intention comprehension scores of both of the intention comprehension results are greater than or equal to the threshold value. In this case, the response determining unit 25C determines that the intention comprehension result of “ControlAirConditioner” is dependent on a speaker and executes the function of lowering the temperature of the air conditioner for the first passenger 1 and the second passenger 2.

Meanwhile, as for functions such as destination search and reproducing music that are not dependent on a speaker but are shared by all passengers, it is not necessary to execute such function for each speaker when intention comprehension results are the same. Therefore, in a case where there are a plurality of identical intention comprehension results and a function that corresponds to the intention comprehension results is not dependent on a speaker, the response determining unit 25C determines a function that corresponds to only an intention comprehension result of the best score. More specifically, let us assume that the speech recognition result of the first passenger 1 is “play music”, that the speech recognition result of the second passenger 2 is “reproduce music”, that the intention comprehension results of the first passenger 1 and the second passenger 2 are “PlayMusic (state=on)”, and that the intention comprehension scores of both of the intention comprehension results are greater than or equal to the threshold value. In this case, the response determining unit 25C determines that the intention comprehension result “PlayMusic” is not dependent on a speaker and executes a function that corresponds to either one of the intention comprehension result of the first passenger 1 and the intention comprehension result of the second passenger 2 that has a higher intention comprehension score.

Next, an example of the operation of the speech recognition device 20 will be described.

FIG. 14 is a flowchart illustrating an example of the operation of the speech recognition device 20 according to the third embodiment. The speech recognition device 20 repeats the operation illustrated in the flowchart of FIG. 14, for example, while the information device 10 is operating. Since steps ST001 to ST005 in FIG. 14 are the same operation as steps ST001 to ST005 in FIG. 6 in the first embodiment, description thereof will be omitted.

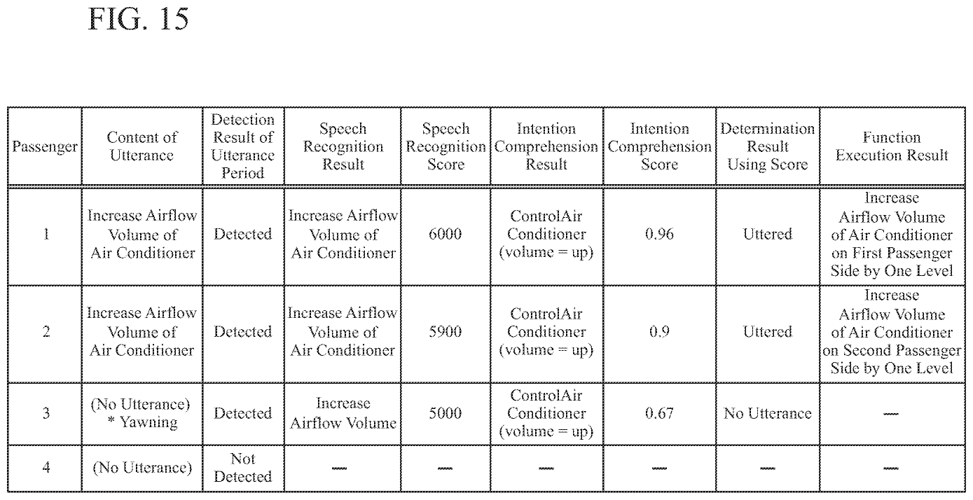

FIG. 15 is a diagram illustrating a processing result by the speech recognition device 20 according to the third embodiment. Here, as an example, description will be given with a specific example illustrated in FIG. 15. In the example of FIG. 15, the first passenger 1 is speaking “increase the airflow volume of the air conditioner” and the second passenger 2 is speaking “increase the airflow volume of the air conditioner”. The third passenger 3 is yawning while the first passenger 1 and the second passenger 2 are speaking. The fourth passenger 4 is not speaking.

In step ST101, the intention comprehension unit 30 executes the intention comprehension process on speech recognition results whose speech recognition score has been determined to be greater than or equal to the threshold value by the score-using determining unit 23C and outputs intention comprehension results and intention comprehension scores to the score-using determining unit 23C. In the example of FIG. 15, since the speech recognition scores of the first passenger 1, the second passenger 2, and the third passenger 3 are all greater than or equal to the threshold value “5000”, the intention comprehension process is executed. The first passenger 1, the second passenger 2, and the third passenger 3 all have the identical intention comprehension result of “ControlAirConditioner (volume=up)”. Meanwhile, the intention comprehension score is “0.96” for the first passenger 1, “0.9” for the second passenger 2, and “0.67” for the third passenger 3. Note that the third passenger 3 has a low intention comprehension score since the intention comprehension process has been performed on the speech recognition result of “increase the airflow volume of the air”, which is an erroneous recognition of the uttered speech of the first passenger 1 and the second passenger 2.

In step ST102, the score-using determining unit 23C determines whether or not there is a plurality of identical intention comprehension results within a certain period of time among the intention comprehension results output by the intention comprehension unit 30. If the score-using determining unit 23C determines that there is a plurality of identical intention comprehension results within a certain period of time (“YES” in step ST102), the score-using determining unit 23C determines in step ST103 whether or not an intention comprehension score of each of the plurality of identical intention comprehension results is greater than or equal to the threshold value and determines that a passenger, who corresponds to an intention comprehension result whose intention comprehension score is greater than or equal to the threshold value, is speaking (“YES” in step ST103). If the threshold value is “0.8”, in the example of FIG. 15, it is determined that the first passenger 1 and the second passenger 2 are speaking. On the other hand, the score-using determining unit 23C determines a passenger who corresponds to an intention comprehension result having an intention comprehension score less than the threshold value as not being speaking (“NO” in step ST103).

If there is a single intention comprehension result output by the intention comprehension unit 30 within a certain period of time, or if there is a plurality of intention comprehension results output by the intention comprehension unit 30 within a certain period of time but is not the same (“NO” in step ST102), the score-using determining unit 23C adopts all the intention comprehension results output by the intention comprehension unit 30. In step ST105, the response determining unit 25C refers to the dialogue management DB 24C and determines (a) function(s) that correspond(s) to all the intention comprehension results output by the intention comprehension unit 30.

In step ST104, the response determining unit 25C refers to the dialogue management DB 24C, and determines whether or not a function, which corresponds to the plurality of identical intention comprehension results having an intention comprehension score greater than or equal to the threshold value adopted by the score-using determining unit 23C, is dependent on a speaker. If the function that corresponds to the plurality of identical intention comprehension results having the intention comprehension score greater than or equal to the threshold value is dependent on a speaker (“YES” in step ST104), the response determining unit 25C determines functions that correspond to the plurality of same respective intention comprehension results in step ST105. On the other hand, if the function that corresponds to the plurality of identical intention comprehension results having the intention comprehension score greater than or equal to the threshold value is not dependent on a speaker (“NO” in step ST104), the response determining unit 25C determines, in step ST106, a function that corresponds to the intention comprehension result having the best score among the plurality of identical intention comprehension results. In the example of FIG. 15, a function that corresponds to the intention comprehension result “ControlAirConditioner” of the first passenger 1 and the second passenger 2 is the operation of the air conditioner and is dependent on a speaker, and thus the response determining unit 25C determines the function of increasing the airflow volume of the air conditioner by one level for the first passenger 1 and the second passenger 2. Therefore, the information device 10 executes the function of increasing the airflow volume of the air conditioner on the first passenger 1 side and the second passenger 2 side by one level.

As described above, the speech recognition device 20 according to the third embodiment includes the speech signal processing unit 21, the speech recognition unit 22, the intention comprehension unit 30, and the score-using determining unit 23C. The speech signal processing unit 21 separates uttered speech of a plurality of passengers seated in a plurality of speech recognition target seats in a vehicle into uttered speech of each of the passengers. The speech recognition unit 22 performs speech recognition on uttered speech of each of the passengers separated by the speech signal processing unit 21 and calculates a speech recognition score. The intention comprehension unit 30 comprehends the intention of utterance for each of the passengers and calculates intention comprehension scores using the speech recognition result of each of the passengers. The score-using determining unit 23C determines to which passenger, an intention comprehension result corresponds, to adopt from among intention comprehension results for the respective passengers using at least one of speech recognition scores or intention comprehension scores of the respective passengers. With this configuration, it is possible to suppress erroneous recognition of speech uttered by another passenger in the speech recognition device 20 used by a plurality of passengers. Furthermore, the speech recognition device 20 includes the intention comprehension unit 30 and thus can comprehend the intention of utterance even when a passenger freely speaks without being aware of recognition target words.

Furthermore, the speech recognition device 20 according to the third embodiment includes the dialogue management DB 24C and the response determining unit 25C. The dialogue management DB 24C is a dialogue management database that defines the correspondence between intention comprehension results and functions to be executed. The response determining unit 25C refers to the response determining unit 25C and determines the function that corresponds to the intention comprehension result adopted by the score-using determining unit 23C. With this configuration, in the information device 10 operated by a plurality of passengers by speech, it is possible to suppress erroneous execution of a function for speech uttered by another passenger. Furthermore, since the speech recognition device 20 includes the intention comprehension unit 30, the information device 10 can execute the function intended by the passenger even when the passenger freely speaks without being aware of recognition target words.

Note that although the example has been described in the third embodiment in which the speech recognition device 20 includes the dialogue management DB 24C and the response determining unit 25C, the information device 10 may include the dialogue management DB 24C and the response determining unit 25C. In this case, the score-using determining unit 23C outputs the adopted intention comprehension result to the response determining unit 25C of the information device 10.

### Fourth Embodiment

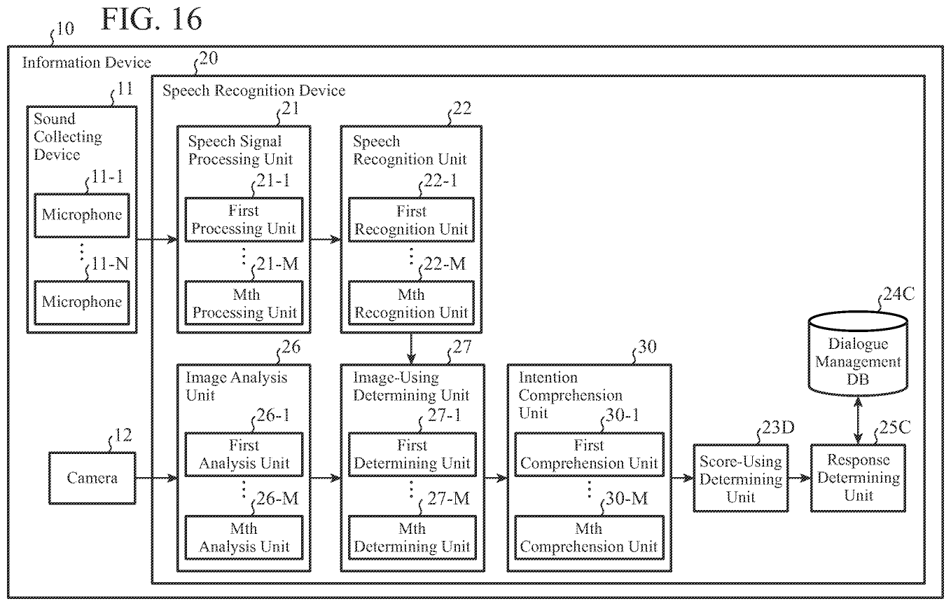

FIG. 16 is a block diagram illustrating a configuration example of an information device 10 including a speech recognition device 20 according to a fourth embodiment. The information device 10 according to the fourth embodiment has a configuration in which a camera 12 is added to the information device 10 according to the third embodiment illustrated in FIG. 13. Furthermore, the speech recognition device 20 according to the fourth embodiment has a configuration in which the image analysis unit 26 and the image-using determining unit 27 of the second embodiment illustrated in FIG. 7 are added to the speech recognition device 20 of the third embodiment illustrated in FIG. 13. In FIG. 16, the same or a corresponding part as that in FIG. 7 and FIG. 13 is denoted by the same symbol, and description thereof is omitted.

An intention comprehension unit 30 receives utterance determination results of respective passengers using an image which are output by the image-using determining unit 27, speech recognition results, and speech recognition scores of the speech recognition results. The intention comprehension unit 30 executes intention comprehension process only on a speech recognition result of a passenger determined to be speaking by the image-using determining unit 27 and does not execute the intention comprehension process on a speech recognition result of a passenger determined to be not speaking by the image-using determining unit 27. Then, the intention comprehension unit 30 outputs intention comprehension results of the respective passengers for which the intention comprehension process has been executed and intention comprehension scores to a score-using determining unit 23D.

The score-using determining unit 23D operates similarly to the score-using determining unit 23C of the third embodiment. However, the score-using determining unit 23D determines which intention comprehension result to adopt using the intention comprehension result that corresponds to the speech recognition result of the passenger determined to be speaking by the image-using determining unit 27 and the intention comprehension score of the intention comprehension result.

Note that although the score-using determining unit 23D determines whether or not to adopt an intention comprehension result using an intention comprehension score as described above, the score-using determining unit 23D may determine whether or not to adopt an intention comprehension result using a speech recognition score calculated by the speech recognition unit 22. In this case, the score-using determining unit 23D may acquire the speech recognition score calculated by the speech recognition unit 22 from the speech recognition unit 22 or via the image-using determining unit 27 and the intention comprehension unit 30. Then, the score-using determining unit 23D determines that, for example, a passenger, who corresponds to an intention comprehension result that corresponds to a speech recognition result having a speech recognition score greater than or equal to the threshold value, is speaking and adopts this intention comprehension result.

Further alternatively, the score-using determining unit 23D may determine whether or not to adopt an intention comprehension result in consideration of not only the intention comprehension score but also at least one of the speech recognition score or a determination score. In this case, the score-using determining unit 23D may acquire the determination score calculated by the image-using determining unit 27 from the image-using determining unit 27 or via the intention comprehension unit 30. Then, the score-using determining unit 23D uses, for example, a value obtained by adding or averaging the intention comprehension score, the speech recognition score, and the determination score instead of the intention comprehension score.

Next, an example of the operation of the speech recognition device 20 will be described.

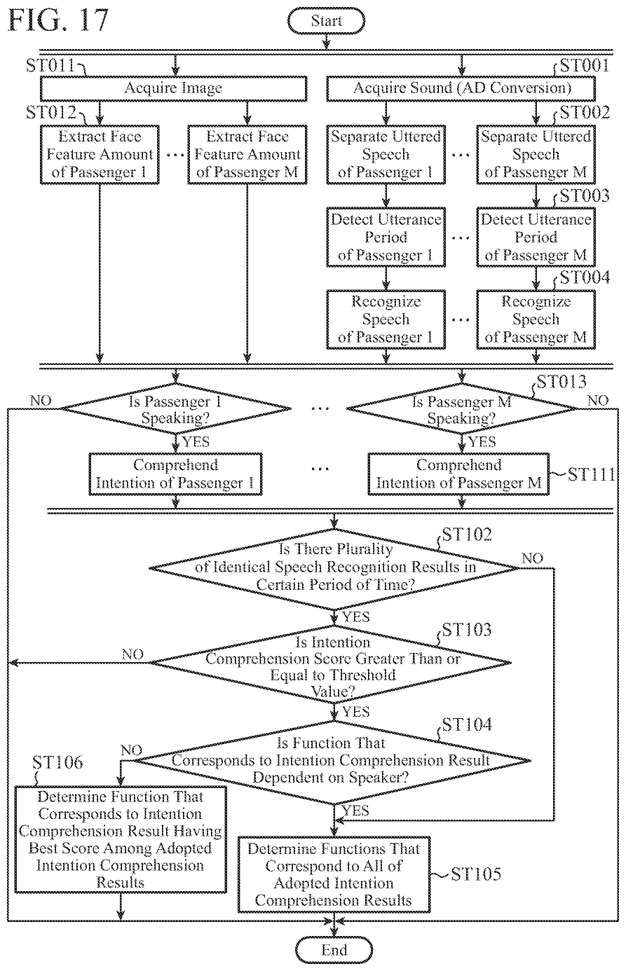

FIG. 17 is a flowchart illustrating an example of the operation of the speech recognition device 20 according to the fourth embodiment. The speech recognition device 20 repeats the operation illustrated in the flowchart of FIG. 17, for example, while the information device 10 is operating. Since steps ST001 to ST004 and steps ST011 to ST013 of FIG. 17 are the same operations as steps ST001 to ST004 and steps ST011 to ST013 of FIG. 11 in the second embodiment, description thereof will be omitted.

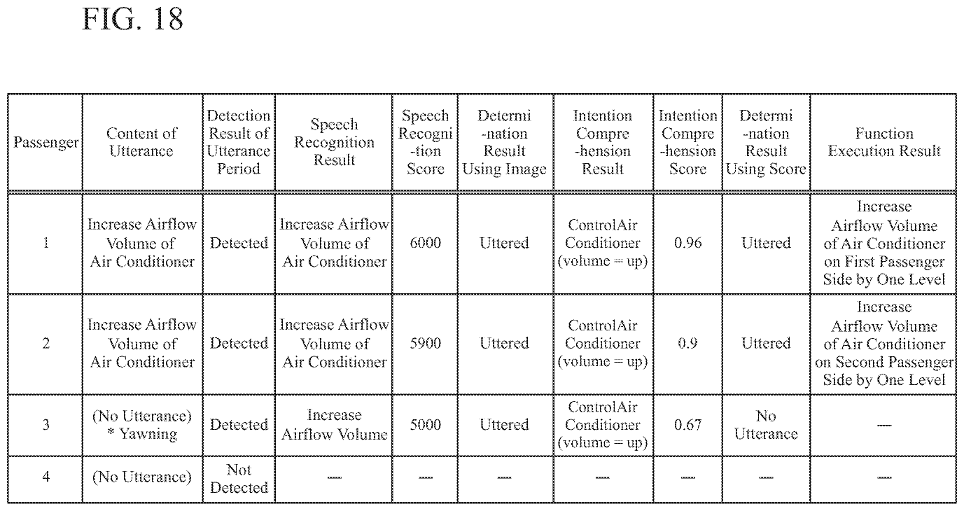

FIG. 18 is a table illustrating a processing result by the speech recognition device 20 according to the fourth embodiment. Here, as an example, description will be given with a specific example illustrated in FIG. 18. Similarly to the example of FIG. 15 in the third embodiment, in the example of FIG. 18, the first passenger 1 is speaking “increase the airflow volume of the air conditioner” and the second passenger 2 is speaking “increase the wind volume of the air conditioner”. The third passenger 3 is yawning while the first passenger 1 and the second passenger 2 are speaking. The fourth passenger 4 is not speaking.

In step ST111, the intention comprehension unit 30 executes the intention comprehension process on speech recognition results that correspond to passengers determined to be speaking by the image-using determining unit 27 and outputs the intention comprehension result and the intention comprehension score to the score-using determining unit 23D. In the example of FIG. 18, the first passenger 1, the second passenger 2, and the third passenger 3 all have spoken or moved the mouth in a manner similar to be speaking and thus are determined to be speaking by the image-using determining unit 27 and subjected to the intention comprehension process.

Since steps ST102 to ST106 in FIG. 17 are the same operation as steps ST102 to ST106 in FIG. 14 in the third embodiment, description thereof will be omitted.

As described above, the speech recognition device 20 according to the fourth embodiment includes the image analysis unit 26 and the image-using determining unit 27. The image analysis unit 26 calculates the face feature amount for each passenger using an image capturing a plurality of passengers. The image-using determining unit 27 determines whether or not each of the passengers is speaking by using the face feature amount from the start time to the end time of uttered speech of each of the passengers. In a case where there are the identical intention comprehension results that correspond to two or more passengers determined to be speaking by the image-using determining unit 27, the score-using determining unit 23D determines whether or not to adopt the intention comprehension results using at least one of the speech recognition scores or the intention comprehension scores of the respective two or more passengers. With this configuration, in the speech recognition device 20 used by a plurality of passengers, it is possible to further suppress erroneous recognition of speech uttered by another passenger.

Note that in a case where there are the identical intention comprehension results that correspond to two or more passengers determined to be speaking by the image-using determining unit 27, the score-using determining unit 23D of the fourth embodiment may determine whether or not to adopt the intention comprehension results using determination scores calculated by the image-using determining unit 27 in addition to at least one of the speech recognition scores or the intention comprehension scores of the respective two or more passengers. With this configuration, the speech recognition device 20 can further suppress erroneous recognition of speech uttered by another passenger.

Furthermore, similarly to the speech recognition unit 22 illustrated in FIG. 12 of the second embodiment, the speech recognition unit 22 of the fourth embodiment may not perform speech recognition on uttered speech of a passenger determined to have no utterance period by the image-using determining unit 27. In this case, the intention comprehension unit 30 is included at a position that corresponds to a position between the speech recognition unit 22 and 23B in FIG. 12. This also results in that the intention comprehension unit 30 does not comprehend the intention of utterance of the passenger determined to have no utterance period by the image-using determining unit 27. With this configuration, the processing load of the speech recognition device 20 can be reduced, and the performance of determining an utterance period is improved.

Lastly, the hardware configuration of the speech recognition devices 20 of the embodiments will be described.

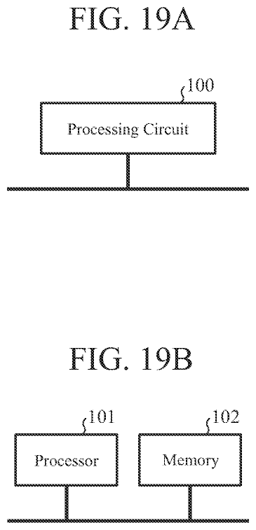

FIGS. 19A and 19B are diagrams each illustrating an exemplary hardware configuration of the speech recognition devices 20 of the embodiments. The functions of the speech signal processing units 21, the speech recognition units 22, the score-using determining units 23, 23B, 23C, and 23D, the dialogue management DBs 24 and 24D, the response determining units 25 and 25C, the image analysis units 26, the image-using determining units 27, and the intention comprehension units 30 in the speech recognition devices 20 are implemented by a processing circuit. That is, the speech recognition device 20 includes a processing circuit for implementing the above functions. The processing circuit may be a processing circuit 100 as dedicated hardware or may be a processor 101 for executing a program stored in a memory 102.

As illustrated in FIG. 19A, in a case where the processing circuit is dedicated hardware, the processing circuit 100 corresponds to, for example, a single circuit, a composite circuit, a programmed processor, a parallel programmed processor, an application specific integrated circuit (ASIC), a programmable logic device (PLC), a field-programmable gate array (FPGA), a system-on-a-chip (SoC), a system large-scale integration (LSI), or a combination thereof. The functions of the speech signal processing units 21, the speech recognition units 22, the score-using determining units 23, 23B, 23C, and 23D, the dialogue management DBs 24 and 24D, the response determining units 25 and 25C, the image analysis units 26, the image-using determining units 27, and the intention comprehension units 30 may be implemented by a plurality of processing circuits 100, or the functions of the respective units may be collectively implemented by a single processing circuit 100.

As illustrated in FIG. 19B, in a case where the processing circuit is the processor 101, the functions of the speech signal processing units 21, the speech recognition units 22, the score-using determining units 23, 23B, 23C, and 23D, the response determining units 25 and 25C, the image analysis units 26, the image-using determining units 27, and the intention comprehension units 30 are implemented by software, firmware, or a combination of software and firmware. The software or the firmware is described as a program, which is stored in the memory 102. The processor 101 reads and executes the program stored in the memory 102 and thereby implements the functions of the above units. That is, the speech recognition device 20 includes the memory 102 for storing the program, execution of which by the processor 101 results in execution of the steps illustrated in the flowchart of FIG. 6, for example. It can also be said that this program causes a computer to execute the procedures or methods of the speech signal processing units 21, the speech recognition units 22, the score-using determining units 23, 23B, 23C, and 23D, the response determining units 25 and 25C, the image analysis units 26, the image-using determining units 27, and the intention comprehension units 30.

Here, the processor 101 includes, for example, a central processing unit (CPU), a graphics processing unit (GPU), a microprocessor, a micro controller, or a digital signal processor (DSP).

The memories 102 may be a nonvolatile or volatile semiconductor memory such as a random access memory (RAM), a read only memory (ROM), an erasable programmable ROM (EPROM), or a flash memory, a magnetic disk such as a hard disk or a flexible disk, an optical disk such as a compact disc (CD) or a digital versatile disc (DVD), or a magneto-optic disc.

The dialogue management DBs 24 and 24D are implemented by the memory 102.

Note that some of the functions of the speech signal processing units 21, the speech recognition units 22, the score-using determining units 23, 23B, 23C, and 23D, the response determining units 25 and 25C, the image analysis units 26, the image-using determining units 27, and the intention comprehension units 30 may be implemented by dedicated hardware, and some may be implemented by software or firmware. In this manner, the processing circuit in the speech recognition device 20 can implement the above functions by hardware, software, firmware, or a combination thereof.

In the above example, the functions of the speech signal processing units 21, the speech recognition units 22, the score-using determining units 23, 23B, 23C, and 23D, the dialogue management DBs 24 and 24C, the response determining units 25 and 25C, the image analysis units 26, the image-using determining units 27, and the intention comprehension units 30 are integrated in an information device 10 that is installed in or brought into a vehicle; however, the functions may be distributed to a server device on a network, a mobile terminal such as a smartphone, and an in-vehicle device, for example. For example, a speech recognition system is constituted by an in-vehicle device including the speech signal processing unit 21 and the image analysis unit 26, and a server device including the speech recognition unit 22, the score-using determining unit 23, 23B, 23C, or 23D, the dialogue management DB 24 or 24C, the response determining unit 25 or 25C, the image-using determining unit 27, and the intention comprehension unit 30.

The present invention may include a flexible combination of the embodiments, a modification of any component of the embodiments, or omission of any component in the embodiments within the scope of the present invention.

### INDUSTRIAL APPLICABILITY

A speech recognition device according to the present invention performs speech recognition of a plurality of speakers, and thus is suitable for use in speech recognition devices for moving bodies including vehicles, trains, ships, or aircrafts in which a plurality of speech recognition targets are present.

### REFERENCE SIGNS LIST

1 to 4: first to fourth passengers, 10, 10A: information device, 11: sound collecting device, 11-1 to 11-N: microphone, 12: camera, 20, 20A: speech recognition device, 21: speech signal processing unit, 21-1 to 21-M: first to Mth processing units, 22: speech recognition unit, 22-1 to 22-M: first to Mth recognition units, 23, 23B, 23C, 23D: score-using determining unit, 24, 24C: dialogue management DB, 25, 25C: response determining unit, 26: image analysis unit, 26-1 to 26-M: first to Mth analysis unit, 27: image-using determining unit, 27-1 to 27-M: first to Mth determining unit, 30: intention comprehension unit, 30-1 to 30-M: first to Mth comprehension unit, 100: processing circuit, 101: processor, 102: memory

1.-12. (canceled)

13. A speech recognition device comprising:
processing circuitry to
individually separate uttered speech of a plurality of passengers each seated in one of a plurality of speech recognition target seats in a vehicle;
perform speech recognition on the separated uttered speech of each of the passengers calculate a speech recognition score;
comprehend intention of utterance of each of the passengers and calculate an intention comprehension score using a speech recognition result of each of the passengers; and
determine an intention comprehension result of which of the passengers is to be used from among intention comprehension results for the respective passengers, using at least one of the speech recognition score or the intention comprehension score of each of the passengers;
calculate a face feature amount for each of the passengers using an image capturing the plurality of passengers; and
determine whether or not there is utterance for each of the passengers using the face feature amount from a start time to an end time of the uttered speech of each of the passengers,
wherein, in a case where there are identical intention comprehension results that correspond to two or more passengers determined to be speaking, the processing circuitry determines an intention comprehension result of which of the passengers is adopted from among the intention comprehension results that correspond to the two or more passengers, using at least one of the speech recognition score or the intention comprehension score of each of the two or more passengers.

14. The speech recognition device according to claim 13,
wherein the processing circuitry determines an utterance period for each of the passengers using the face feature amount of each of the passengers,
the processing circuitry does not perform speech recognition on uttered speech of a passenger determined to have no utterance period, and
the processing circuitry does not comprehend intention of utterance of the passenger determined to have no utterance period.

15. The speech recognition device according to claim 13, further comprising:
a dialogue management database to define correspondence between intention comprehension results and functions to be executed,
wherein the processing circuitry determines a function that corresponds to an intention comprehension result adopted by referring to the dialogue management database.

16. The speech recognition device according to claim 13,
wherein the processing circuitry calculates a determination score indicating reliability of determination as to whether or not there is utterance for each of the passengers, and
in a case where there are identical intention comprehension results that correspond to two or more passengers determined to be speaking, the processing circuitry determines whether or not to adopt the intention comprehension results using the determination score in addition to at least one of the speech recognition score or the intention comprehension score of each of the two or more passengers.

17. A speech recognition system comprising:
processing circuitry to
individually separate uttered speech of a plurality of passengers each seated in one of a plurality of speech recognition target seats in a vehicle;
perform speech recognition on the separated uttered speech of each of the passengers and calculate a speech recognition score;
comprehend intention of utterance of each of the passengers and calculating an intention comprehension score using a speech recognition result of each of the passengers; and
determine an intention comprehension result of which of the passengers is to be used from among intention comprehension results for the respective passengers, using at least one of the speech recognition score or the intention comprehension score of each of the passengers;
calculate a face feature amount for each of the passengers using an image capturing the plurality of passengers; and
determine whether or not there is utterance for each of the passengers using the face feature amount from a start time to an end time of the uttered speech of each of the passengers,
wherein, in a case where there are identical intention comprehension results that correspond to two or more passengers determined to be speaking, the processing circuitry determines an intention comprehension result of which of the passengers is adopted from among the intention comprehension results that correspond to the two or more passengers, using at least one of the speech recognition score or the intention comprehension score of each of the two or more passengers.

18. A speech recognition method comprising:
individually separating uttered speech of a plurality of passengers each seated in one of a plurality of speech recognition target seats in a vehicle;
performing speech recognition on the separated uttered speech of each of the passengers and calculating a speech recognition score;
comprehending intention of utterance of each of the passengers and calculating an intention comprehension score using a speech recognition result of each of the passengers;
determining an intention comprehension result of which of the passengers is to be used from among intention comprehension results for the respective passengers, using at least one of the speech recognition score or the intention comprehension score of each of the passengers;
calculating a face feature amount for each of the passengers using an image capturing the plurality of passengers;
determining whether or not there is utterance for each of the passengers using the face feature amount from a start time to an end time of the uttered speech of each of the passengers; and
determining an intention comprehension result of which of the passengers is adopted from among the intention comprehension results that correspond to the two or more passengers, using at least one of the speech recognition score or the intention comprehension score of each of the two or more passengers in a case where there are identical intention comprehension results that correspond to two or more passengers determined to be speaking.
